(19) United States
(12) Patent Application Publication
(10) Pub. No.: US 2022/0382101 A1
(43) Pub. Date: Dec. 1, 2022

(54) DISPLAY DEVICE AND POLARIZER

(71) Applicant: Shenzhen China Star Optoelectronics Semiconductor Display Technology Co., Ltd., Shenzhen, Guangdong (CN)

(72) Inventor: Haijun WANG, Shenzhen, Guangdong (CN)

(21) Appl. No.: 17/419,775

(22) PCT Filed: May 28, 2021
(86) PCT No.: PCT/CN2021/096600

§ 371 Date: Jun. 30, 2021

(30) Foreign Application Priority Data
Dec. 18, 2020 (CN) 202011501939.8

(51) Int. Cl. G02F 1/1335; G02F 1/1368; G02F 1/1362; G02F 1/1333; G02F 1/133

(52) U.S. Cl. CPC G02F 1/133528; G02F 1/1368; G02F 1/136209; G02F 1/133305; G02F 1/133302; G02F 1/13312; G02F 2202/28; G02F 2201/50

(57) ABSTRACT

A display device and a polarizer are provided. The display device includes a laminated polarizer and a display layer, and the polarizer includes a sensing layer and a thin film layer. The sensing layer is disposed on the thin film layer, and the sensing layer is provided with a plurality of sensing elements, a plurality of switches, and a protective layer covering the plurality of sensing elements and the plurality of switches. The sensing elements sense changes of external light to generate an induced current and to transmit the induced current to the switches, and the switches control a display change of the display layer according to the induced current.

### FIELD OF INVENTION

This application relates to a field of display technology, and specifically relates to a display device and a polarizer.

### BACKGROUND OF INVENTION

With development of display technology, liquid crystal displays can realize additional functions such as color temperature sensing, gas sensing, or the like, while achieving high-quality display effects. However, when manufacturing this kind of multifunctional liquid crystal displays, current manufacturing method usually adds a cover plate to an outermost layer of a display, and the cover plate needs to be provided with an adhesive layer to be bonded to other structures of the display. Alternatively, sensing devices in the display will be arranged on a glass substrate, and the glass substrate itself has a thicker thickness, which ultimately results in a thicker liquid crystal display.

### TECHNICAL PROBLEM

When adding functional devices to the display, it is necessary to arrange the functional devices on the glass substrate, which will cause the display to be too thick.

### SUMMARY OF INVENTION

The embodiments of the present application provide a display device and a polarizer, the display device can realize laser sensing. In addition, the display device is thinner than the current laser sensing display device.

In a first aspect, an embodiment of the present application provides a display device. The display device includes a polarizer and a display layer arranged in a stack, wherein the polarizer includes a sensing layer and a thin film layer, the sensing layer is disposed on the thin film layer. The sensing layer is provided with a plurality of sensing elements, a plurality of switches, and a protective layer covering the plurality of sensing elements and the plurality of switches. The sensing elements are configured to sense changes of external light to generate an induced current and to transmit the induced current to the switches, and the switches are configured to control a display of the display layer according to the induced current.

In the display device provided by an embodiment of the present application, the sensing layer includes a light-shielding portion, and the light-shielding portion is disposed on the switch.

In the display device provided by an embodiment of the present application, the light-shielding portion includes a recessed portion, an opening of the recessed portion faces the thin film layer, and the switch is disposed in the recessed portion.

In the display device provided by an embodiment of the present application, the sensing layer includes a flexible substrate, and the plurality of sensing elements and the plurality of switches are disposed on the flexible substrate.

In the display device provided by an embodiment of the present application, the display device further includes a first adhesive layer, and the first adhesive layer is provided between the sensing layer and the thin film layer.

In the display device provided by an embodiment of the present application, the sensing layer is disposed on the thin film layer.

In a second aspect, an embodiment of the present application provides a polarizer, the polarizer includes a sensing layer and a thin film layer, the sensing layer is disposed on the thin film layer, and the sensing layer is configured to sense light changes of the external environment.

### BENEFICIAL EFFECT

The present application reduces the thickness of the displays.

### DESCRIPTION OF DRAWINGS

In order to describe the technical solutions more clearly in the embodiments of the present application, the following will briefly introduce the drawings needed in the description of the embodiments. Obviously, the drawings in the following description are only some embodiments of the present application. For those skilled in the art, without creative work, other drawings can be obtained based on these drawings.

FIG. 1 is a schematic diagram of a first structure of a display device provided by an embodiment of the present application.

FIG. 2 is a schematic diagram of a first structure of a sensing layer provided by an embodiment of the present application.

FIG. 3 is a schematic diagram of a second structure of the sensing layer provided by an embodiment of the present application.

FIG. 4 is a schematic diagram of a third structure of the sensing layer provided by an embodiment of the present application.

FIG. 5 is a schematic diagram of a first structure of a polarizing layer provided by an embodiment of the present application.

FIG. 6 is a schematic diagram of a second structure of the display device provided by an embodiment of the present application.

FIG. 7 is a schematic diagram of a third structure of the display device provided by an embodiment of the present application.

FIG. 8 is a schematic diagram of a second structure of the polarizing layer provided by an embodiment of the present application.

FIG. 9 is a schematic structural diagram of a display layer provided by an embodiment of the present application.

FIG. 10 is a schematic diagram of a fourth structure of the display device provided by an embodiment of the present application.

### DETAILED DESCRIPTION OF PREFERRED EMBODIMENTS

The following will clearly and completely describe the technical solutions in the embodiments of the present application with reference to the drawings in the embodiments of the present application. Obviously, the embodiments are only a part of the embodiments of the present application, rather than all the embodiments. Based on these embodiments in this application, all other embodiments obtained by those skilled in the art without creative work shall fall within the protection scope of this application.

In the description of this application, the terms “first” and “second” are only used for description purposes, and cannot be understood as indicating or implying relative importance or implicitly indicating the number of indicated technical features. Therefore, the features defined with “first” and “second” may explicitly or implicitly include one or more of the features. In the description of the present application, “plurality” means two or more than two, unless otherwise specifically defined.

The following disclosure provides many different embodiments or examples for realizing different structures of the present application. In order to simplify the disclosure of the present application, the components and settings of specific examples are described below. However, they are only examples and are not intended to limit the application. In addition, this application may repeat reference numbers and/or reference letters in different examples. This repetition is for the purpose of simplification and clarity and does not indicate the relationship between the various embodiments and/or settings discussed. In addition, this application provides examples of various specific processes and materials, but those of ordinary skill in the art may be aware of the application of other processes and/or the use of other materials.

With the development of display technology, more and more types of displays are on the market. For example, while realizing basic display functions, the displays can realize functions such as gas sensing, color temperature sensing, and laser sensing. When manufacturing such multifunctional displays, the current manufacturing process will cause the thickness of the displays to be thick, which has become a problem to be solved.

Based on the above technical problem, the present application provides a display device. The display device can realize the functions of sensing environmental parameters, and the environmental parameters include parameters such as laser, color temperature, and the like. In addition, the display device also has the characteristics of being thin and light. Detailed descriptions are described as follows.

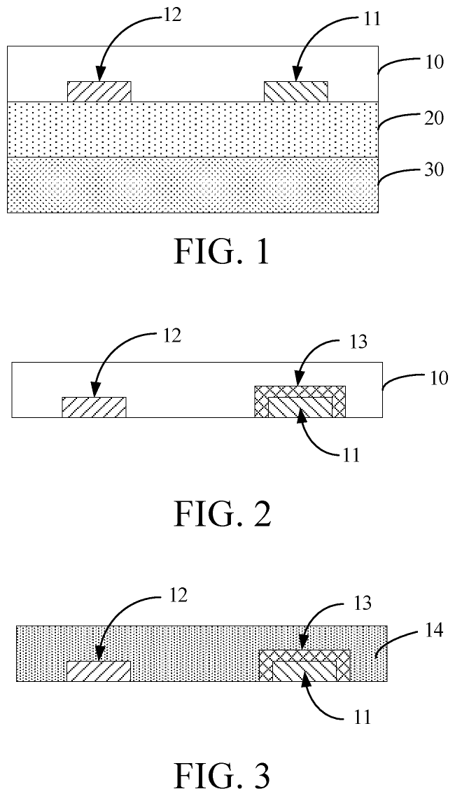

Please refer to FIG. 1, which is a first structural diagram of a display device provided by an embodiment of the present application.

The display device includes a sensing layer 10, a thin film layer 20, and a display layer 30. Wherein, the thin film layer 20 is provided between the sensing layer 10 and the display layer 30, and the sensing layer 10 and the thin film layer 20 can be integrated to form a polarizer of the display device. The sensing layer 10 includes a plurality of switches 11 and a plurality of sensing elements 12, and the plurality of sensing elements 12 can sense changes of external light, such as laser or light of specific colors. The sensing element 12 can also be used to sense other environmental parameters, such as a distance between a person or an object and the display device.

In some embodiments, the sensing layer 10 and the thin film layer 20 can be arranged adjacently, and the thin film layer 20 and the display layer 30 can be arranged adjacently. The sensing layer 10 and the thin film layer 20 can be integrated to form a polarizer.

In some embodiments, the sensing element 12 may be composed of a thin film transistor with a photosensitive function. When sensing element 12 receives changes in the external environment parameter, it can generate an induced current. When the switch 11 receives the induced current, the state of the switch 11 can be controlled according to the induced current. The switch 11 is electrically connected to the display layer 30. By changing the state of the switch 11, the switch 11 can periodically transmit the signal that controls the display layer 30, so that the display layer 30 can display different effects according to the control signal transmitted by the switch 11. For example, different colors, brightness, contrast, etc. are displayed. Wherein, the switch 11 can be a thin film transistor switch.

For another example, when sensing element 12 receives laser irradiation, the sensing element 12 generates an induced current, and at the same time, the switch 11 is periodically turned on. When multiple switches 11 work, a position of laser irradiation is determined by the induced current generated from the sensing element 12, to control the display changes of the display device at the position.

The thin film layer 20 can control the polarization direction of a specific light beam. When natural light emitted by the display layer passes through the thin film layer 20, the light whose vibration direction is perpendicular to a transmission axis of the thin film layer 20 will be absorbed, and the transmitted light only leaves a polarized light whose vibration direction is parallel to the transmission axis of the thin film layer 20. It finally controls the display device to display a normal screen.

In some embodiments, the display device can be a liquid crystal display (LCD) device, and the display layer 30 may include liquid crystals for display.

Please refer to FIG. 2, which is a schematic diagram of a first structure of a sensing layer 10 provided by an embodiment of the present application. Wherein, the sensing layer 10 further includes a light-shielding portion 13, and the light-shielding portion 13 is provided with a recessed portion whose opening faces the thin film layer 20, and the switch 11 is disposed in the recessed portion. The wall around the recessed portion can block the light from the non-switch areas. In addition, the stability of the operation of the switch 11 can be improved.

Please also refer to FIG. 3, which is a schematic diagram of a second structure of the sensing layer 10 provided by an embodiment of the present application. The switch 11 and the light-shielding portion 13 are disposed in the protective layer 14, and the sensing element 12 is disposed in the protective layer 14. The protective layer 14 can protect the switch 11 and the sensing element 12 from being affected by the external environment. For example, the protective layer 14 can protect the switch 11 and the sensing element 12 from external forces, and it can block water and other gases that may damage the switch 11 and the sensing element 12.

In some embodiments, the switch 11 and the sensing element 12 can be formed on the substrate (as a carrier) first, then the light-shielding portion 13 is formed, and finally the protective layer 14 is formed. The protective layer 14 can be made of a liquid glue or a protective film. The liquid glue is applied to the switch 11, the sensing element 12, and the light-shielding portion 13. Then, by adding other materials that chemically react with the glue to make it solidify, the glue will be solidified and shaped to form an adhesive layer as the protective layer 14. Alternatively, the glue is irradiated with specific light to make it solidify and shape. For example, ultraviolet light is irradiated to solidify the glue to form an adhesive layer as the protective layer 14.

In the embodiments of this application, the use of the cover plate can be eliminated. The protective layer 14 is used as a protective shell to protect the display device, thereby reducing the thickness of the display device. In addition, the function of sensing external environmental parameters of the display device is further realized.

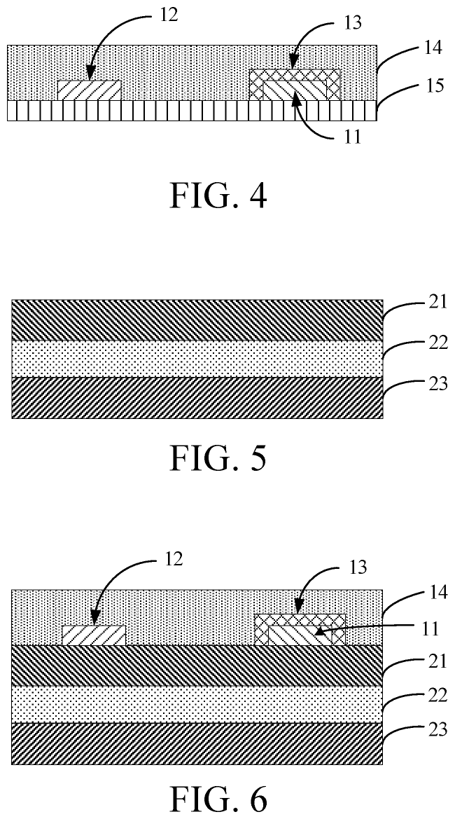

Please also refer to FIG. 4, which is a schematic diagram of a third structure of the sensing layer 10 provided by an embodiment of the present application. The sensing layer 10 further includes a flexible substrate 15. The flexible substrate 15 has excellent high-temperature resistance, mechanical properties, and chemical resistance. The switch 11 and the sensing element 12 can be disposed on the flexible substrate 15. In addition, the flexible substrate 15 has characteristics of lightweight and thin thickness, which can make the display device thinner in the manufacturing of the display device. The material of the flexible substrate 15 can be a polyimide film (PI), i.e., a PI film.

Please refer to FIG. 5, which is a schematic diagram of a first structure of a thin film layer 20 provided by an embodiment of the present application. The thin film layer 20 includes a first thin film layer 21, a second thin film layer 22, and a third thin film layer 23. The first thin film layer 21, the second thin film layer 22, and the third thin film layer 23 are laminated in order.

Wherein, the first thin film layer 21 and the third thin film layer 23 can be triacetyl cellulose (TAC) films. The first thin film layer 21 and the third thin film layer 23 have characteristics of high light transmittance, good water resistance, and a certain degree of mechanical strength, which can protect the second thin film layer 22.

In the thin film layer 20, the second thin film layer 22 plays a role in controlling the polarization direction of a specific light beam. The second thin film layer 22 can be a polyvinyl acetate (PVA) film. The PVA film is mainly composed of atoms such as carbon, hydrogen, and oxygen, which have high transparency and high ductility, as well as good iodine adsorption and film-forming characteristics.

Please refer to FIG. 6, which is a second schematic diagram of a structure of the display device provided by an embodiment of the present application. Wherein, the sensing layer 10 can be disposed on the first thin film layer 21. Specifically, a plurality of switches 11 and a plurality of sensing elements 12 can be formed on the first thin film layer 21 first, and then the light-shielding portion 13 and the protective layer 14 can be formed.

In the embodiment of the present application, the sensing layer 10 is directly disposed on the first thin film layer 21, so that the thickness of the display device is further reduced. For example, the switch 11 and the sensing element 12 can be formed on the first thin film layer 21, and then the light-shielding portion 13 and the protective layer 14 can be formed. The sensing layer 10 can be used as the outermost layer of the display device facing the outside environment, and the protective layer 14 of the sensing layer 10 plays a role in protecting the internal elements of the display device.

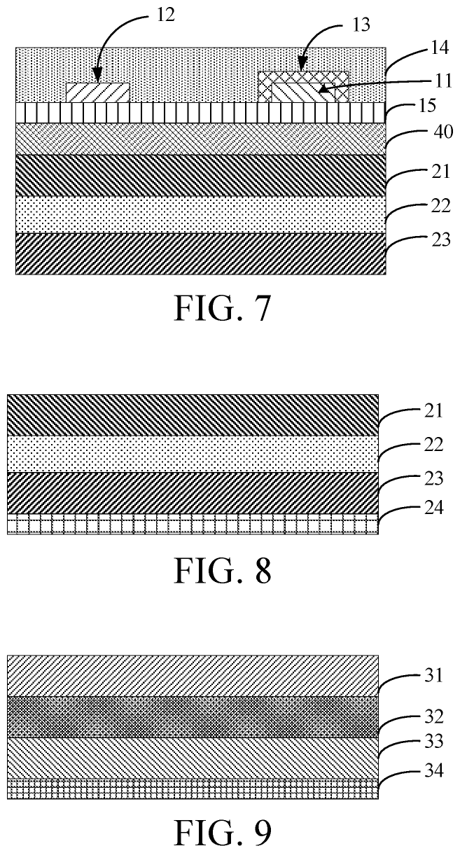

Please refer to FIG. 7, which is a third structural diagram of a display device provided by an embodiment of the present application. Wherein, the display device further includes a first adhesive layer 40, and the first adhesive layer 40 is provided between the sensing layer 10 and the thin film layer 20 so that the sensing layer 10 and the thin film layer 20 can be bonded.

In some embodiments, the flexible substrate 15 of the sensing layer 10 can be directly attached to a side of the first adhesive layer 40 away from the thin film layer 20, and the side of the first adhesive layer 40 facing the thin film layer 20 is attached to the first thin film layer 21. In this way, the sensing layer 10 and the thin film layer 20 are bonded, thereby enhancing the mechanical strength of the display device.

Please refer to FIG. 8, which is a schematic diagram of a second structure of the thin film layer 20 provided by an embodiment of the present application. Wherein, the thin film layer 20 further includes a second adhesive layer 24. The second adhesive layer 24 is disposed on a side of the third thin film layer 23 away from the sensing layer 10, and the third thin film layer 23 can be disposed on the second adhesive layer 24. The second adhesive layer 24 can be a pressure-sensitive film.

Please refer to FIG. 9, which is a schematic structural diagram of a display layer provided by an embodiment of the present application. The display layer 30 includes a first glass layer 31, a liquid crystal layer 32, a second glass layer 33, and a second polarizing layer 34.

The first glass layer 31 is disposed on a side facing the thin film layer 20, and the liquid crystal layer 32 is provided between the first glass layer 31 and the second glass layer 32. The second glass layer 33 is disposed on a side away from the thin film layer 20, and the second polarizing layer 34 is disposed on a side of the second glass layer 32 away from the liquid crystal layer 32.

In some embodiments, a color resist layer can be further disposed on the first glass layer 31. The color resist layer includes red, green, and blue color resists. When light emits from the liquid crystal layer 32, it can be filtered by the color resist layer. Through the combination of red, green, and blue pixels, different colors are finally realized on the display device.

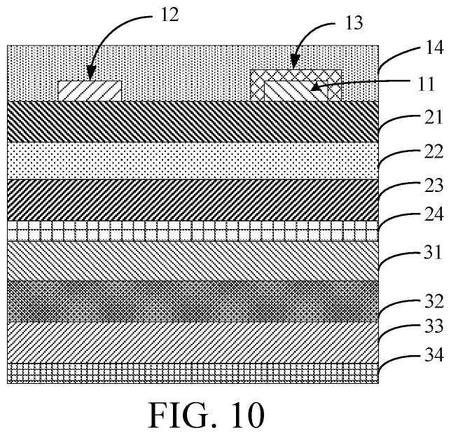

Please refer to FIG. 10, which is a fourth structural diagram of a display device provided by an embodiment of the present application. A side of the second adhesive layer 24 facing the display layer 30 can be attached to the first glass layer 31, and a side of the second adhesive layer 24 away from the first glass layer 31 can be attached to the third thin film layer 23.

In some embodiments, a fourth thin film layer is further provided on a side of the second adhesive layer 24 facing the display layer. The second adhesive layer 24 is disposed on the fourth thin film layer, and the fourth thin film layer is bonded to the display layer 30 by a glue.

In the embodiments of the present application, in order to further reduce the thickness of the display device, the glue on the fourth thin film layer and the glue between the fourth thin film layer and the display layer 30 can be removed, and the fourth thin film layer can be directly bonded to the first glass layer 31 of the display layer 30 though the second adhesive layer 24. That is, a side of the second adhesive layer 24 away from the third thin film layer 23 is disposed on the first glass layer 31, thereby reducing the thickness of the display device.

In the embodiment of the present application, when an external laser or other trigger conditions trigger the induction of the plurality of sensing elements 12 in the sensing layer 10, the plurality of sensing elements 12 can transmit the induced current to the plurality of corresponding switches 11. The plurality of switches 11 can transmit a signal to the display layer 30 according to the induced current to change the display effect of the display layer 30. Finally, the display device can display images with colors, brightness, contrast, etc. that need to be displayed.

In addition, by eliminating the cover plate on the side of the sensing layer 10 away from the first polarizing layer, by eliminating the glass substrate or flexible substrate 15 in the sensing layer 10, and by eliminating the fourth thin film layer of the thin film layer 20, the thickness reduction of the display device is realized.

The embodiment of the present application further provides a manufacturing method of a display device. The display device manufactured by the manufacturing method can sense external environmental parameters, thereby controlling display change of the display device. In addition, the thickness of the display device manufactured by the manufacturing method is less than that of the conventional display device.

First, the first thin film layer 21 of the thin film layer 20 can be used as a base of the sensing layer 20, wherein the first thin film layer 21 can be a TAC film.

Then, a plurality of switches 11 and a plurality of sensing elements 12 are formed on the first thin film layer 21. Wherein, when the sensing element 12 receives light whose light intensity is greater than the preset light intensity, the sensing element 12 can generate an induced current. When the switch 11 receives the induced current, the state of the switch 11 can be controlled according to the induced current.

The light-shielding portion 13 is disposed on the switch 11. Specifically, it can be formed by a physical vapor deposition (PVD) method, such as a vacuum evaporation method, a sputtering coating method, and so on, to deposit the material of the light-shielding portion 13 on the switch 11.

Then, a protective layer 14 is formed. The protective layer 14 can protect the switch 11 and the sensing element 12. The protective layer 14 can be made of liquid glue or a protective film. Next, the liquid glue is applied to the switch 11, the sensing element 12, and the light-shielding portion 13. Afterwards, by adding other materials that chemically react with the glue to make it solidify, the glue can be solidified and formed to form the protective layer 14. Alternatively, the glue is irradiated with specific light to solidify and shape. For example, ultraviolet light is irradiated to solidify and shape the glue to form the protective layer 14. After the protective layer 14 is completed, the sensing layer 10 and the thin film layer 20 are adjacent to each other. Alternatively, a protective film may be covered on the plurality of switches 11 and the plurality of sensing elements 12 to form the protective layer 14.

Then, the thin film layer 20 is disposed on the display layer 30 by attaching the second adhesive layer 24 to the first glass layer 31, and the display layer 30 and the film layer 20 are adjacent to each other. Finally, the manufacturing of the display device is completed.

Wherein, the switch 11 is electrically connected to the display layer 30. By changing the state of the switch 11, the switch 11 can periodically transmit the signal that controls the display layer 30 so that the display layer 30 can display different effects according to the control signal transmitted by the switch 11. For example, images with different colors, brightness, contrast, etc. are displayed. Wherein, the switch 11 can be a thin film transistor switch.

In the embodiment of the present application, by eliminating the cover plate on the side of the sensing layer 10 away from the first polarizing layer, the sensing layer 10 directly serves as the outermost layer of the display device, and the glass substrate in the sensing layer 10 is eliminated to further reduce the thickness of the display device. The completed display device also has characteristics of being thin and light.

The above describes in detail a display device provided by an embodiment of the present application. Specific examples are used in this article to describe the principles and implementation of the application, and the description of the above examples is only used to help understand the methods and core ideas of the application. For those skilled in the art, according to the idea of this application, there will be changes in the specific implementation and the scope of this application. In summary, the content of this specification should not be construed as a limitation to the application.

What is claimed is:

1. A display device, comprising a polarizer and a display layer arranged in a stack, wherein the polarizer comprises a sensing layer and a thin film layer, the sensing layer is disposed on the thin film layer; and
wherein the sensing layer is provided with a plurality of sensing elements, a plurality of switches, and a protective layer covering the plurality of sensing elements and the plurality of switches, the plurality of sensing elements are configured to sense changes of external light to generate an induced current and to transmit the induced current to the plurality of switches, and the plurality of switches are configured to control a display of the display layer according to the induced current.

2. The display device according to claim 1, wherein the protective layer comprises an adhesive layer or a protective film, and the adhesive layer or the protective film covers the plurality of sensing elements and the plurality of switches.

3. The display device according to claim 1, wherein the sensing layer further comprises:
a light-shielding portion disposed on a side of one of the switches away from the display layer.

4. The display device according to claim 3, wherein the light-shielding portion comprises a recessed portion, an opening of the recessed portion faces the thin film layer, and one of the switches is disposed in the recessed portion.

5. The display device according to claim 1, wherein the thin film layer comprises a first thin film layer, a second thin film layer, and a third thin film layer arranged in a stack.

6. The display device according to claim 5, wherein the sensing layer is disposed on the first thin film layer.

7. The display device according to claim 6, wherein the sensing layer comprises a flexible substrate, and the plurality of sensing elements and the plurality of switches are disposed on the flexible substrate.

8. The display device according to claim 7, wherein the flexible substrate is disposed on the first thin film layer.

9. The display device according to claim 5, further comprising:
a first adhesive layer disposed between the sensing layer and the thin film layer.

10. The display device according to claim 9, wherein the first adhesive layer is disposed on the first thin film layer.

11. The display device according to claim 5, further comprising:
a second adhesive layer, wherein the third thin film layer is disposed on the second adhesive layer.

12. The display device according to claim 11, wherein the display layer comprises a first glass layer, a liquid crystal layer, a second glass layer, and a second polarizing layer arranged in a stack, the display layer is configured to display an image.

13. The display device according to claim 12, wherein the second adhesive layer is disposed on the first glass layer.

14. The display device according to claim 13, further comprising:
a fourth thin film layer disposed between the second adhesive layer and the first glass layer.

15. A polarizer, comprising:
a sensing layer and a thin film layer, wherein the sensing layer is disposed on the thin film layer, and the sensing layer is configured to sense light changes of an external environment.

16. The polarizer according to claim 15, wherein the sensing layer comprises:
a plurality of sensing elements and a plurality of switches, the plurality of sensing elements and the plurality of switches are disposed on the thin film layer, the plurality of sensing elements are configured to sense changes of external light to generate an induced current and transmit the induced current to the plurality of switches, and the plurality of switches are configured to change their states according to the induced current.

17. The polarizer according to claim 16, wherein the sensing layer further comprises:
a protective layer covering the plurality of sensing elements and the plurality of switches.

18. The polarizer according to claim 16, wherein the sensing layer comprises a flexible substrate, and the plurality of sensing elements and the plurality of switches are disposed on the flexible substrate.

19. The polarizer according to claim 15, wherein the thin film layer comprises a first thin film layer, a second thin film layer, and a third thin film layer arranged in a stack.

20. The polarizer according to claim 19, wherein the sensing layer is disposed on the first thin film layer.
